(19) United States
(12) Patent Application Publication
(10) Pub. No.: US 2023/0383864 A1
(43) Pub. Date: Nov. 30, 2023

(54) MODULAR VACUUM VALVE SYSTEM FOR A VACUUM TRANSPORT SYSTEM

(71) Applicant: VAT HOLDING AG, Haag (CH)

(72) Inventors: Hanspeter FREHNER, Sevelen (CH); Martin NETZER, Bludenz (AT); Doré DE MORSIER, Zürich (CH); Pascal Manuel FINKER, Rüthi (CH); Fabio Alejandro DUBOIS, Zürich (CH)

(21) Appl. No.: 18/249,520

(22) PCT Filed: Oct. 15, 2021
(86) PCT No.: PCT/EP2021/078578

§ 371 Date: Apr. 18, 2023

(30) Foreign Application Priority Data
Oct. 19, 2020 (DE) 10 2020 006 403.5

(51) Int. Cl. F16K 51/02; F16K 3/12

(52) U.S. Cl. CPC F16K 51/02; F16K 3/12

(57) ABSTRACT

Disclosed is a vacuum valve system for a vacuum transport system, including a valve seat assembly having a first valve opening defining an opening axis and a first sealing surface surrounding the first valve opening; a closure component for closing of the first valve opening with a second sealing surface corresponding to the first sealing surface; and a drive unit for the closure component. The valve seat assembly can be combined with the transport tube to provide a gas-tight transition between the valve seat assembly and the transport tube, and the first valve opening. At least the valve seat assembly and the closure component are formed as separate system components that can be modular, and the closure component the valve seat assembly can be modular so that the open position and the closed position for the closure component is driven by the drive unit.

The invention relates to a vacuum valve system for substantially gas-tight closure of an opening or volume for a vacuum transport system according to the preamble of claim 1.

In general, vacuum valves for the essentially gas-tight closure of a stream path, flow path or beam path leading through an opening formed in a valve housing are known in various embodiments from the prior art. Vacuum valves are used in particular in the field of IC and semiconductor manufacturing but also, for example, in the field of electron microscopy, which also has to take place in a protected atmosphere as far as possible without the presence of contaminating particles.

Another application of such or similar valves can be found, for example, in the field of transport systems. Pneumatic tube systems and vacuum transport systems should be mentioned here. Pneumatic tube transport is a form of fast and low-personnel transport of objects in small, cylindrical containers by means of e.g. compressed air or/and vacuum in tubes of constant caliber (typically up to approx. 20 cm).

A vacuum transport system as understood herein differs from a pneumatic tube system particularly in the size of the transported objects (significantly larger than 20 cm) and the lower internal pressure present in the tube system.

In general, these vacuum transport systems each propose a similar basic principle. In each case, it is a high-speed transport system in which capsules or other vehicles travel at very high speeds, especially close to the speed of sound, in a largely evacuated tube with a guide system, e.g. on a rail system, an air cushion or magnetically repelled sliding. In the vicinity of stations, linear motors can enable high accelerations, as in a magnetic levitation train, while electrically powered compressors can generate sufficient propulsion when cruising speed is reached. Alternatively, a corresponding drive can be provided on the part of the object moving in the tube.

A vacuum transport system of this kind has, for example, reinforced concrete supports with two adjacent travel tubes made of steel or another suitable material, e.g. metal-like, metal-containing or concrete-like material, in which at least a rough or fine vacuum prevails. The vacuum is intended to enable travel speeds of up to just above the speed of sound by reducing the air resistance within the transport tube. Capsules or vehicles with space for several passengers can be moved or loads transported in the tubes (e.g. cars).

The capsules or vehicles should be moved in a sliding manner with as little friction as possible. For this purpose, for example, the use of an electromagnetic levitation system is proposed.

For example, the capsules or vehicles can be made primarily of aluminum or alternative lightweight materials and have a diameter of at least two meters. Furthermore, an unladen weight of 3 to 3.5 metric tons is proposed, and a payload of between 12 and 25 metric tons may be provided.

The transport tubes can have an inner diameter of slightly more than the capsule diameter and a wall thickness of at least 20 mm. The internal pressure can be maintained at, for example, about 100 Pascal (1 millibar). The support piers carrying the transport tubes may be positioned with an average spacing of about 30 meters and may be secured against earthquakes by damping elements. It is understood that the transport tubes can also be at least partially underground, for example by analogy with a subway, etc., or designed as tunnels.

A problem for the operation of such a vacuum transport system is generally the creation and maintenance of a desired vacuum within the system. In particular, large losses of the internal vacuum can occur during unloading or loading or during removal or insertion of a transport vehicle into the transport tube.

A further problem is the fulfillment of safety requirements, in particular those imposed by the authorities, so that possible hazards can be avoided as far as possible during operation of the system. Particularly when transporting people, but also when transporting goods (e.g. hazardous goods), it is essential that the safety equipment provided enables people or goods to be evacuated from the transport tube unharmed in the event of an emergency.

One approach to solving the above problems is the integration of a plurality of separating devices along the tube. On the one hand, such separating devices can be used to atmospherically separate certain station areas along the line from the tube and make them ventilated and accessible for loading and unloading. After the loading activity, the area is then closed off again, evacuated and the separating devices opened.

On the other hand, the separating devices can be provided at certain regular intervals along the route. This allows a certain section of the transport tube to be closed in an emergency and then ventilated so that an evacuation of people and/or goods can be initiated.

For the above-mentioned tasks, the separating devices must provide a reliable and robust seal for the transport tube when closed. In addition, the sealing effect must be reliably reproducible during multiple opening and closing processes.

Due to the large number of such separating devices, the construction and installation of the separating devices can involve considerable effort. The separating device is typically manufactured completely and must then be transported to its destination and installed there. On the one hand, this requires a high degree of transport capacity and great expertise in the installation of a separating device.

It is therefore the object of the present invention to provide a separating device, in particular a vacuum valve system, which reduces or avoids the above-mentioned disadvantages.

In particular, it is an object of the invention to provide a vacuum valve system that provides improved design and installation conditions with reliable and robust operation of the valve.

These objects are solved by the realization of the characterizing features of the independent claims. Features which further form the invention in an alternative or advantageous manner are to be taken from the dependent claims.

The invention relates to a vacuum valve system for substantially gas-tight closing of a first valve opening, in particular vacuum slide valve or gate valve, for a vacuum transport system. The vacuum transport system has a transport tube for transporting an object inside and along the transport tube. The vacuum valve system has a valve seat assembly having the first valve opening defining an opening axis and a first sealing surface surrounding the first valve opening. In addition, a closure component is provided for substantially gas-tight closing of the first valve opening with a second sealing surface corresponding to the first sealing surface, and a drive unit is provided for providing movement of the closure component relative to the valve seat assembly in such a way that the closure component moves from an open position, in which the closure component at least partially releases the first valve opening, to a closed position in which a first sealing material (seal) present between the first sealing surface and the second sealing surface contacts the first sealing surface and the second sealing surface and closes the first valve opening in a substantially gas-tight manner, and back. In particular, the sealing material is arranged either on the first sealing surface or on the second sealing surface, e.g. vulcanized, glued or clamped.

The valve seat assembly can be combined with the transport tube in such a way that a gas-tight transition is provided between the valve seat assembly and the transport tube and the first valve opening corresponds to a tube cross-section or a tube opening, in particular with regard to shape, dimensioning and/or position. In particular, the valve opening can be provided concentrically to the tube opening.

At least the valve seat assembly and the closure component are designed as separate system components that can be combined in a modular manner and interact in combination, and the closure component can be combined in a modular manner with the valve seat assembly in such a way that the open position and the closed position for the closure component can be provided by means of the movement that can be provided by the drive unit.

In one embodiment, the closure component may include at least one closure side configured to interact with the first sealing surface, wherein a progression of the second sealing surface defines an extension plane for the closure component, and the closure component includes at least one coupling element for coupling the closure component to the drive unit, wherein the coupling element extends in the extension plane or parallel to the extension plane.

The coupling element can be, for example, a bracket or suspension, in particular with a bearing for connection to the drive unit.

In particular, the vacuum valve system can have a guide component coupled to the coupling element, wherein the coupling to the coupling element is configured in such a way that the closure component can be displaced by means of the coupling relative to the guide component in a direction orthogonal to the plane of extension, in particular parallel.

The guide component may have, for example, rollers, wheels, or other sliding or rolling means that to enable generic mobility of the closure component.

Alternatively, the guide component may comprise a rail. The guide component is intended to interact with a guide on the side of the valve seat assembly.

In one embodiment, the valve seat assembly may have a second valve opening and a third sealing surface surrounding the second valve opening, wherein the second valve opening is opposite the first valve opening and an opening axis defined by the second valve opening is coaxial or parallel to the opening axis of the first valve opening. The closure component may be correspondingly configured for substantially gas-tight closure of the second valve opening and have a fourth sealing surface corresponding to the third sealing surface.

By arranging two such pairs of sealing surfaces associated with two different valve openings, an optional sealing of one of the two openings can be provided. This is of particular importance when the valve system is used as an emergency system to close off a tunnel section. Here, the side of the valve on which such an emergency occurs remains undetermined. Thus, the system must preferably provide the possibility of sealing both sides.

In a further embodiment, the progressions of the first and second sealing surfaces can each have a first and a second main section and two side sections. The two main sections lie in planes that are at right angles to the opening axis and are spaced apart from one another. The two main sections are each connected by the respective two side sections.

In particular, the seal (sealing material) may have a Y-shaped cross-section, with the two legs of the cross-section contacting the first sealing surface of the valve seat assembly in the closed position.

The invention further relates to a valve seat assembly for a vacuum valve system of a vacuum transport system, wherein the vacuum transport system has a transport tube for transporting an object internally along the transport tube. The valve seat assembly includes a valve opening defining an opening axis and a first sealing surface surrounding the valve opening.

The valve seat assembly is designed as a system component that can be combined in a modular manner with a closure component of the vacuum valve system and interacts in a combined state. The valve seat assembly can also be combined with the transport tube in such a way that a gas-tight transition is provided between the valve seat assembly and the transport tube and the valve opening corresponds to a tube cross-section of the transport tube.

It is understood that a valve seat assembly of the vacuum valve system may be formed in accordance with any of the embodiments of a valve seat assembly described or shown herein.

In one embodiment, the valve seat assembly can be designed as an insert element for insertion into a receptacle on the transport system side, wherein a spatial extension and shape of the insert element is provided in such a way that the insert element can be inserted into the receptacle with an exact fit and, by inserting the insert element into the receptacle, a valve seat for the vacuum valve system is provided for closing and opening the vacuum transport system as a whole or in segments.

The valve seat can thus be formed as an insert. The advantage of this design is that the valve seat can be constructed without a housing, and the housing and thus also most of the sealing against the surrounding atmosphere is provided by the transport system. This results in improved and more efficient construction and transport.

In one embodiment, the valve seat assembly may be provided by a valve tube segment of the vacuum transport system, wherein the valve seat assembly is formed as a non-detachable, fixedly connected part of the vacuum transport system and is integrated into the vacuum transport system, in particular is integrated integrally.

This provides an integrated and thus highly robust design of the valve seat assembly.

In particular, the valve seat assembly can be designed as a cast part of the vacuum transport system, in particular molded as a mineral casting, metal casting or concrete casting. The valve seat assembly can thus be erected at the intended destination (on-site) and provided by casting a specific casting material into an appropriately shaped mold. A typical transport effort and installation of the valve seat assembly can be omitted accordingly.

In one embodiment, the valve seat assembly may comprise a guide and a receiving arrangement for receiving the closure component, wherein the guide provides guidance for movement of the closure component from an open position to a closed position and back. The guide may comprise, for example, a rail system or rollers and may extend over a distance at least equal to twice the diameter of the transport tube. This can provide positioning of the valve closure (valve disc) in the open position and the closed position.

In one embodiment, the valve seat assembly may have a spatial extension in at least one direction of at least 2 times the diameter of the transport tube of the vacuum transport system.

In one embodiment, the valve seat assembly may include a second valve opening and a third sealing surface surrounding the second valve opening, wherein the second valve opening is opposite the first valve opening and an opening axis defined by the second valve opening extends coaxially or parallel to the opening axis of the first valve opening.

The valve seat assembly thus offers full inerrability into a vacuum transport system. The transport tube can be connected to both valve sides, i.e. to each valve opening, whereby the valve seat assembly provides direct transport also directly through the valve (in open state). In addition, a flexible sealing of one of the valve openings and thus of a respective tube section is provided as required.

The invention further relates to a vacuum transport system comprising a transport tube for transporting an object inside and along the transport tube, wherein a negative pressure, in particular a vacuum, can be provided inside the transport tube relative to the surrounding atmosphere. The vacuum transport system further comprises a vacuum valve system as described above, wherein the vacuum valve system is integrated into the vacuum transport system and connected to the transport tube.

The valve seat assembly is connected to the transport tube in such a way that a gas-tight transition is provided between the valve seat assembly and the transport tube, and the vacuum valve system and the transport tube form an overall enclosed assembly providing separation between the surrounding atmosphere and an interior of the vacuum transport system.

The valve seat assembly provides the first valve opening and the first sealing surface inside the vacuum transport system. The first valve opening corresponds to a transport tube cross-section, in particular with respect to size, position and/or shape. The valve seat assembly and the closure component are combined and thus interact. A controlled movement of the closure component into the open position and into the closed position can be provided by means of the drive unit. An inner volume of the vacuum transport system can be closed as a whole or in segments, in particular can be separated, and can be opened.

In one embodiment, the object may be a transport means, in particular a capsule or a vehicle, wherein the transport means is designed to transport a person and/or goods.

The vacuum transport system can accordingly have a tube diameter of several meters, at least two meters. In particular, the vacuum valve system has a dimension of at least four meters in at least one spatial direction. The vacuum transport system may be formed by integrating the vacuum valve system with an emergency system for closing off a tunnel section, or may have a lock device for introducing and removing objects into and from the transport system.

The invention further relates to a casting tool, in particular a mold or shuttering, for producing a valve seat assembly described herein. The casting tool defines an internal volume having at least one filling opening for introducing a casting material.

The inner volume defines an outer wall with a transport tube opening, in particular with two opposing transport tube openings, wherein the transport tube opening is defined in such a way that the transport tube opening corresponds to a transport tube of a vacuum transport system in terms of shape and spatial extension (cross-section, diameter, etc.). The inner volume defines an inner structure and the inner structure in turn defines a valve opening and a first sealing surface surrounding the valve opening.

The casting tool is designed to be multi-part or closable in such a way that the inner volume can be provided by assembling or closing the casting tool and the inner volume can be dissolved by separating or opening the casting tool.

In particular, an opening axis defined by the valve opening extends coaxially or parallel to a tube axis defined by the transport tube opening.

The casting tool or shuttering can thus be built and provided on-site and subsequently filled with the casting material, whereby a valve seat assembly can be provided after hardening.

Accordingly, the invention relates to a method for producing a valve seat assembly of a vacuum valve system of a vacuum transport system comprising the steps of:
providing a casting tool as described herein,
positioning the casting tool close to or in contact with a transport tube of a vacuum transport system,
introducing a casting material into the casting tool,
hardening of the casting material and
opening or separating and removing the casting tool.

This enables the production of a valve seat on site without the need for transport or installation of the valve seat.

Accordingly, the invention extends to a valve seat assembly obtainable by a method from above.

The devices according to the invention are described in more detail below by means of concrete exemplary embodiments shown schematically in the drawings, purely by way of example, and further advantages of the invention are also discussed. The figures show in detail:

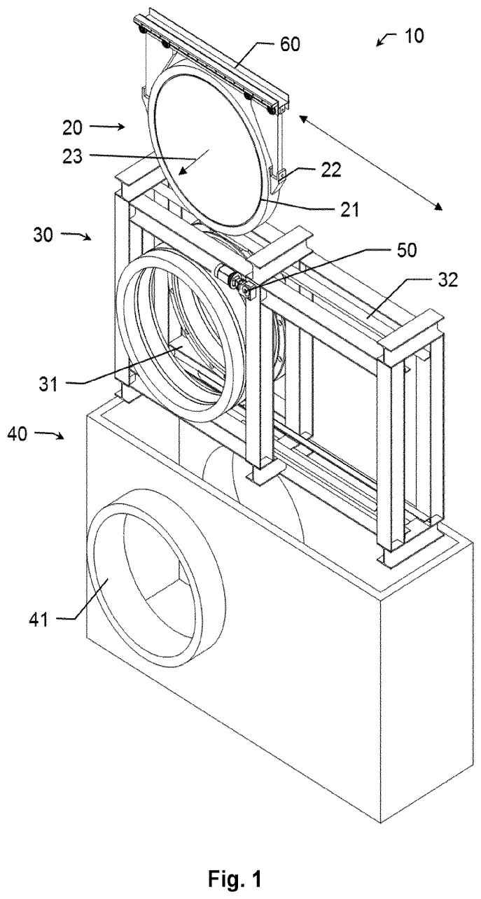

FIG. 1 shows an embodiment of a vacuum valve system according to the invention for closing an opening or sealing a volume;

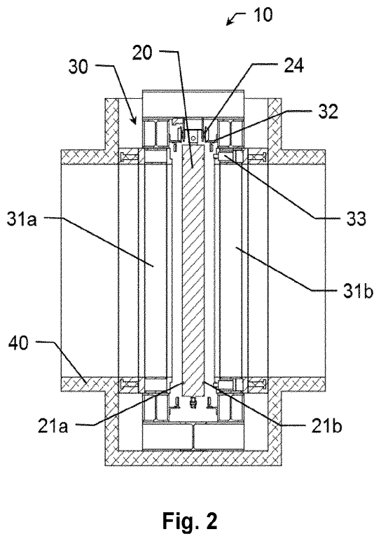

FIG. 2 shows a further embodiment of a vacuum valve system according to the invention for closing an opening or sealing a volume;

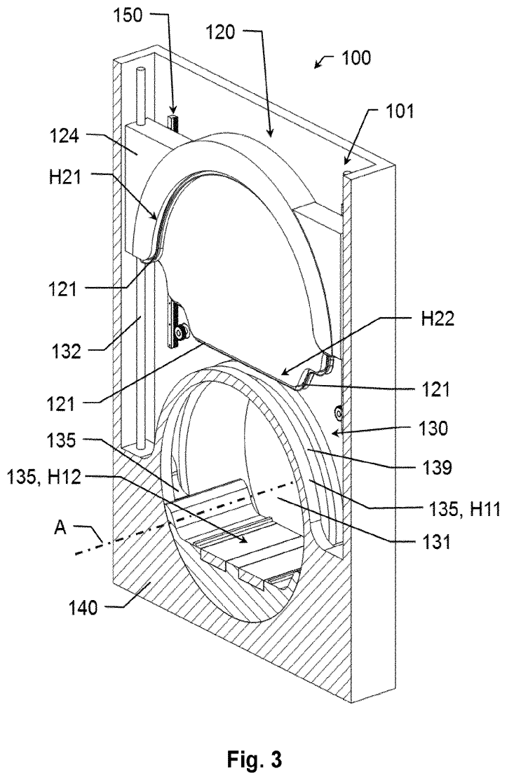

FIG. 3 shows a further embodiment of a vacuum valve system according to the invention for use in a vacuum transport system; and

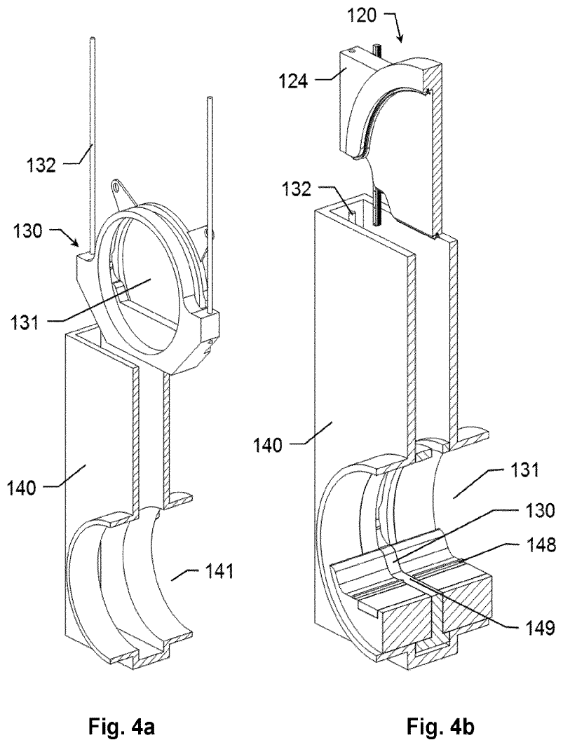

FIGS. 4a-b show a modular design of a vacuum valve system according to the invention.

FIG. 1 shows a vacuum valve system 10 according to the invention for use in a vacuum transport system.

The vacuum valve system 10 has a closure component 20, in particular a valve disc, and a valve seat assembly 30. The closure component 20 is designed for substantially gas-tight closure of a valve opening 31 with a sealing surface 21. The valve seat assembly 30 also has a sealing surface which corresponds to the sealing surface 21 of the closure component 20, i.e. is designed in particular in terms of shape and spatial extension in such a way that, when the sealing surfaces make contact with one another, a complete seal of the opening 31 is provided all the way around the valve opening 31.

The closure component 20 and the valve seat assembly 30 are shown here in a manner where they can be assembled separately and modularly. In one embodiment as shown here, the closure component 20 and the valve seat assembly 30 are further manufactured separately from a housing 40. In another embodiment, the housing 40 may also include the valve seat assembly 30 and provide functionalities thereof. In particular, the valve seat assembly 30 may be formed as a cast element. Such a combination then forms a housing of the valve system, a valve seat for cooperating with the valve disc 20, and a part of the vacuum transport system.

The closure component 20 can be designed, as shown here, as a round valve disc. In addition to the sealing surface 21, the valve disc can have a further, opposite sealing surface (i.e. on a rear side not shown in the perspective illustration), wherein the valve seat also has a further sealing surface corresponding to this sealing surface. This has the advantage that a seal can be made in both directions, i.e. irrespective of which side of the valve disc 20 has a negative pressure relative to the other side.

This functionality is particularly advantageous for use as an emergency disconnection of the transport tube in a vacuum transport system. The occurrence of a corresponding emergency, i.e., for example, the occurrence of a leak at the tube or the failure of the electrical supply and thus the failure of the drive system, obviously cannot be predicted. In particular, the location of such an emergency cannot be predetermined. Thus, such an event can occur on either side of an installed closure component 20. This in turn requires the possibility of being able to create a seal of the tube against both sides.

The valve closure 20 includes a coupling element 22 for coupling the closure component 20 to a drive unit 50. The coupling element 22 may extend in an extension plane of the valve closure or parallel to the extension plane. The extension plane for the closure component 20 may be defined, for example, by the course of the second sealing surface 21.

The vacuum valve system 10 further comprises a guide component 60 coupled to the coupling element 22. A coupling of the guide component 60 to the coupling element 22 is designed in this case in such a way that the closure component 20 can be displaced by means of the coupling relative to the guide component 60 in a direction 23 orthogonally to the plane of extension, in particular parallel to the plane of extension.

The guide component 60 is configured to interact with a guide 32 of the valve seat assembly 30. The guide 32 provides a guide for movement of the closure component 20 from an open position to a closed position and back. In particular, the guide 32 has a rail system and the guide component 60 has corresponding rollers guided on the rails.

In the open position, the closure 20 is vertically offset from the valve opening 31 in such a way that the opening 31 is in particular completely uncovered. In the closed position, the disc 20 is pushed over the valve opening 31, in particular concentrically, and a sealing surface of the disc presses on the corresponding sealing surface of the valve seat.

The closure component 20 can (as shown in FIG. 1) be modularly combined with the valve seat assembly 30, in particular inserted therein. With the insertion, the guide component 60 can be brought into interaction with the guide 32 as well as the drive unit 50.

For this purpose, the closure component 20 and the valve seat assembly 30 are manufactured to match each other in such a way that a vacuum valve as intended can be provided by assembling them.

The valve opening 31 is shaped and dimensioned in such a way that, in an open position, a transport capsule or a transport vehicle of a vacuum transport system can be moved through this opening. In particular, the valve opening 31 has an inner diameter of at least two meters.

The two elements closure component 20 and valve seat assembly 30, together with the drive unit 50, provide a vacuum valve system 10 according to the invention.

The valve seat assembly 30 may be designed as an insert for insertion into a housing 40 provided for this purpose.

An advantage of the proposed vacuum valve system 10 is its modular design. The valve seat or the entire arrangement around the valve seat can be prefabricated and inserted into a housing provided for this purpose, which preferably forms part of the vacuum transport system. Accuracies and manufacturing tolerances can be suitably defined in advance, allowing easy installation and assembly of the valve at its destination.

The valve closure 20 may already be designed in combination with the valve seat assembly 30. Alternatively, the valve closure 20 may be manufactured and transported separately from the valve seat assembly 30. Any preliminary calibrations or movement accuracies that would require careful and gentle (low impact) transportation are not present here, and consequently result in easier transportation. This design makes a site-side combination of the closure component 20 with the valve seat assembly 30 comparatively simple.

According to one variant, a housing 40 as shown can first be provided for a vacuum transport system at specific intervals along the transport tube. The housing 40 can be provided and created for this purpose, for example, already during assembly or casting of the transport system. In the case of casting, a corresponding shuttering can be provided, wherein a transition 41 of the transport tube into the housing can thus already be created and formed. The casting of the housing 40 can be carried out, for example, by means of vacuum-compatible concrete or with another mineral casting material. Alternatively, the housing can be provided as a finished part and connected to the transport tube.

The insert 30 is then inserted into the housing 40. The insert is designed to fit the housing 40 in such a way that, after insertion, the valve opening 31 of the insert 30 in particular corresponds to an opening in the housing for the transport tube, i.e. in particular its spatial extension and position are adapted to the opening for the transport tube.

In this case, the housing 40 can already be designed and manufactured in coordination with the design of the valve seat assembly 30.

After insertion of the valve seat assembly 30, a gas-tight transition may be provided between the valve seat assembly 30 and the transport tube. This can be achieved, for example, by manual sealing of the transition or by a sealing device provided structurally on the part of the valve seat assembly 30 and/or the housing 40. The sealing device may, for example, take the form of a bellows, with the bellows being expanded after insertion into the housing to provide a gas-tight seal. Alternatively, a sealing tube could also be conceivable, which is filled with gas after insertion and is thus pressed into a gap between the valve seat assembly 30 and the housing 40.

After inserting and connecting the valve seat assembly 30 into and to the housing 40, the valve closure 20 may be inserted into the installed valve seat assembly 30 in a subsequent step.

In the assembled state, the valve closure 20 hangs from the guide component 60 and can be moved horizontally on the rail system 32 by means of rollers. In the open position, the valve closure 20 fully releases the valve opening 31, i.e. the closure 20 is horizontally displaced (in the direction of the right side of FIG. 1). In this state, the valve closure 20 can be present freely suspended, i.e. the closure 20 contacts the valve seat assembly 30 exclusively by means of the guide component 60.

In the embodiment shown, the valve closure 20 has opposite closure sides on both sides (only one side is shown here due to the perspective view). A sealing surface is associated with each closure side. As shown, the valve seat assembly 30 has two opposing valve openings. Accordingly, the valve seat assembly 30 has sealing surfaces on both sides, each of which surrounds the valve openings and corresponds to the sealing surfaces of the valve closure 20.

To close the vacuum valve system 10, the valve disc 20 is first moved in such a way that the disc covers both valve openings. This movement can be provided by means of the drive unit 50. In this overlapping intermediate position, there is still no contact between a valve disc sealing surface and a corresponding valve seat sealing surface.

The displacement of the closure 20 from the intermediate position to the closed position can be passive, i.e. by an applied pressure difference, or active, i.e. by an active transverse displacement of the disc 20.

In the passive case, the valve closure 20 can be held without contact between the two valve openings, e.g. by means of corresponding retaining systems (e.g. magnetic or mechanical), until the intermediate position is reached. After reaching the intermediate position, the retaining system can be released and the current pressure difference moves the disc 20 in the direction of the vacuum side, resulting in contact of the valve disc sealing surface with the respectively corresponding valve seat sealing surface and providing a seal of the tube.

In the active case, wherein e.g. the magnitude of the differential pressure is not sufficient for passive closing, transverse movement elements are provided which can provide an active movement of the valve disc 20 in the direction of both valve openings. This active movement is preferably also performed after the intermediate position has been reached. The transverse movement elements can be, for example, plungers or rams that are mechanically driven or can be provided in the form of magnets.

FIG. 2 shows a cross-sectional view of an embodiment of a vacuum valve system 10 according to the invention for use in a vacuum transport system.

The vacuum valve system 10 has a closure component 20, in particular a valve disc, and a valve seat assembly 30. The closure component 20 is designed for substantially gas-tight closure of the valve openings 31a and 31b of the valve seat assembly 30 with respective sealing surfaces 21a and 21b. The valve seat assembly 30 also has two sealing surfaces which correspond to the sealing surfaces 21a and 21b of the closure component 20, i.e. is designed in particular with respect to shape and spatial extension in such a way that, when the sealing surfaces make contact with one another, a complete seal of the opening 31a or 31b is provided around the respective valve opening 31a or 31b.

The closure component 20 and the valve seat assembly 30 are shown here in an assembled state. However, these are modular and can be easily separated.

The closure component 20 is suspended from a guide component that has rollers 24, which in turn rest on a guide 32. The guide 32 has two rails. With this suspension, the closure component 20 can be moved into an open position, an intermediate position and a closed position. FIG. 2 shows the closure component 20 in an intermediate position, i.e. the closure component 20 covers the valve openings 31a and 31b, but is not (yet or no longer) in contact with the valve seat 30.

Actuators 33 are provided for actively bringing the sealing surface 21a into contact with the corresponding sealing surface on the valve seat side, which can generate a transverse force on the valve closure 20 in the direction of the valve opening 31a. In other words, the valve disc 20 can be pressed onto the sealing surface around the valve opening 31a by means of the actuators 33.

Corresponding actuators are also provided for the opposite movement in the direction of the valve opening 31b (not shown), so that sealing of the valve opening 31b can be provided in an analogous manner.

FIG. 3 shows another embodiment of a vacuum valve system 100 according to the invention for use in a vacuum transport system.

The vacuum valve system 100 has a closure component 120, in particular a valve disc, and a valve seat assembly 130. The closure component 120 is designed for substantially gas-tight closure of a valve opening 131 with a sealing surface 121. The sealing surface 121 has a seal. The valve seat assembly 130 also has a sealing surface 135 which corresponds to the sealing surface 121 of the closure component 20, i.e. is designed in particular in terms of shape and spatial extension in such a way that, when the sealing surfaces or the intervening sealing material (seal) come into contact with one another, a complete seal of the opening 131 is provided all the way around the valve opening 131.

The closure component 120 and the valve seat assembly 130 are arranged in a housing 140. The housing 140 forms part of a vacuum transport system and provides the arrangement of the valve system 100 along a transport tube of the vacuum transport system and for closing off the tube by closing the valve.

In the embodiment shown in FIG. 3, a type of valve is shown that allows the valve opening 131 to be closed by means of a single linear, vertical movement of the closure component 120. By this closing movement, a complete sealing of the valve opening 131 can be achieved.

Furthermore, a guide system with a seat-side guide 132 and a closure-side guide component 124 is provided. The guide 132 here has two guide rods along which the valve closure 120 can be moved.

The sealing material provided at the sealing surface 121 of the valve closure 120 may, for example, have a Y-profile or be a sealing cord with a round cross-section.

In FIG. 3, the sealing surface 135 is shown extending in sections offset from each other. A first main section H11 of the sealing surface is located in the shaft 101, in particular on the outer wall of the transport tube. The sealing material of the sealing surface 121 rests here in the closed position. Due to the lateral bearing and guiding 132, 124 of the sealing component 120, space can be advantageously saved compared to conventional shaft guides which drive the sealing component 120 from above.

The closure component 120 is planar throughout, except for a shoulder in the upper portion that supports the seal in the main section H21. In the main section H22, the sealing material abuts the main section H12 of the sealing surface 135 in the closed position. The main sections H11 and H21 lie in a first plane, which is perpendicular to the opening axis A. The main sections H12 and H22 lie in a second plane, which is also perpendicular to the opening axis A. The first plane and the second plane are axially offset from each other (relative to the opening axis A). This offset is bridged by side sections of the sealing surfaces.

The sealing surface 135 surrounds the valve opening 131, and the circumferentially enclosed integral seal at the sealing surface 121 is consequently configured to interact with the sealing surface 135 so that the valve opening can be closed in a gas-tight manner.

A drive unit 150 provides such a movement of the closure component 120 relative to the valve opening 131 that the closure component 120 is adjustable orthogonally to the opening axis A from the open position to the closed position and back.

When the vacuum valve is fully open, the closure component 120 fully enters the shaft 101 through the slot 139.

FIGS. 4a and 4b show a modular embodiment of a vacuum valve system according to the invention. In analogy to the embodiment according to FIG. 1, the closure component 120 and the valve seat assembly 130 of the vacuum valve system are each provided individually and separately from one another and can also be installed on-site in the housing 140 individually.

The valve disc 120 can be modularly combined with the valve seat assembly 130, in particular connected to the guide 132. With the insertion, the guide component 124 can be brought into cooperation with the guide 132.

For this purpose, the closure component 120 and the valve seat assembly 130 are manufactured to match each other in such a way that a vacuum valve in accordance with the intended use can be provided by assembling them.

The valve opening 131 is shaped and dimensioned in such a way that, in an open position, a transport capsule or a transport vehicle of a vacuum transport system can be moved through this opening. In particular, the valve opening 131 has an inner diameter of at least two meters.

The valve seat assembly 130 can be designed as an insert for insertion into a housing 140 provided for this purpose.

An advantage of the proposed vacuum valve system is its modular design. The valve seat or the entire arrangement around the valve seat can be prefabricated and inserted into a housing 140 provided for this purpose, which preferably forms part of the vacuum transport system. Accuracies and manufacturing tolerances can be suitably defined in advance, enabling simple installation and assembly of the valve at its destination.

The valve closure 120 can be manufactured and transported separately from the valve seat assembly 130. Any preliminary calibrations or movement accuracies that would require careful and gentle (low impact) transport are not present here and consequently result in easier transport. This design makes a site-side combination of the closure component 120 with the valve seat assembly 130 comparatively simple.

According to one variant, a housing 140 as shown can first be provided for a vacuum transport system at specific intervals along the transport tube. The housing 140 can be provided and created for this purpose, for example, already during assembly or casting of the transport system. In the case of casting, a corresponding shuttering can be provided, wherein a transition of the transport tube into the housing can thus already be created and formed. The casting of the housing 140 can be carried out, for example, by means of vacuum-compatible concrete or with another mineral casting material. Alternatively, the housing can be provided as a finished part and connected to the transport tube.

The insert 130 is then inserted into the housing 140. The insert 130 is designed to fit the housing 140 in such a way that after insertion the valve opening 131 of the insert 130 in particular corresponds to an opening 141 on the housing side for the transport tube, i.e. in particular its spatial extension and position is adapted to the opening 141 for the transport tube.

In this case, the housing 140 can already be designed and manufactured in coordination with the design of the valve seat assembly 130.

After insertion of the valve seat assembly 130, a gas-tight transition can be provided between the valve seat assembly 130 and the transport tube. This can be achieved, for example, by manual sealing of the transition or by a sealing device provided structurally on the part of the valve seat assembly 130 and/or the housing 140. The sealing device may, for example, take the form of a bellows, with the bellows being expanded after insertion into the housing to provide a gas-tight seal. Alternatively, a sealing tube would also be conceivable, which is filled with gas after insertion and is thus pressed into a gap between the valve seat assembly 130 and the housing 140.

After inserting and connecting the valve seat assembly 130 into and to the housing 140, the valve closure 120 may be inserted into the installed valve seat assembly 130 in a subsequent step.

In the assembled state, the valve closure 120 is guided vertically along the guide 132 by the guide component 124. In the open position, the valve closure 120 fully exposes the valve opening 131, i.e. the closure 120 is vertically offset relative to the valve opening 131 (here: upwards).

The valve closure 120 has a circumferential sealing surface with seal according to FIG. 3. Correspondingly, the valve seat assembly 130 has a corresponding sealing surface.

To close the vacuum valve system, the valve disc 120 is moved vertically downwards until the seal makes circumferential contact with the sealing surface on the valve seat side. Due to the purely vertical movement of the valve disc 120, the closing of the valve opening can take place comparatively quickly even under the influence of the gravitational force acting on the disc 120. This is particularly advantageous in an emergency. In the simplest case, the release of a brake, which is then to be understood as a drive unit, can lead to the closing movement.

Due to the comparatively slim design of the disc 120, i.e. with a less solid and thus thinner wall thickness, the sealing of the opening can be performed by contacting a region 149 with the sealing material, wherein in this region 149 there is an interruption of a guide system 148 provided for guiding the transport vehicle, exemplarily shown here as a rail.

By providing such an interruption area, the integration of the valve system into the transport system can be realized comparatively easily. This also has the advantage that the guide system does not first have to be removed in a first step for the tube to be sealed, so that sufficient contact and thus sealing can be achieved by the sealing material, but the sealing material can be pressed on directly without any preceding steps. This means that sealing can be carried out much faster and more reliably than with previously known solutions.

It is understood that the figures shown are only schematic illustrations of possible exemplary embodiments. According to the invention, the various approaches can also be combined with each other and with valves for closing transport systems of the prior art.

1. A vacuum valve system for substantially gas-tight closing of a first valve opening, in particular a vacuum slide valve or gate valve, for a vacuum transport system, wherein the vacuum transport system comprises a transport tube for transporting an object inside and along the transport tube, comprising
a valve seat assembly, comprising the first valve opening defining an opening axis and a first sealing surface surrounding the first valve opening,
a closure component for substantially gas-tight closing of the first valve opening with a second sealing surface corresponding to the first sealing surface, and
a drive unit for providing movement of the closure component relative to the valve seat assembly in such a way that the closure component moves from an open position, in which the closure component at least partially releases the first valve opening, to a closed position in which a first sealing material present between the first sealing surface and the second sealing surface contacts the first sealing surface and the second sealing surface and the first valve opening is closed in a substantially gas-tight manner, and back, wherein
the valve seat assembly can be combined with the transport tube in such a way that a gas-tight transition is provided between the valve seat assembly and the transport tube, and the first valve opening corresponds to a tube cross-section,
at least the valve seat assembly and the closure component are formed as separate system components which can be combined in a modular manner and interact in a combined state, and
the closure component can be modularly combined with the valve seat assembly in such a way that the open position and the closed position for the closure component can be provided by means of the movement which can be provided by the drive unit.

2. The vacuum valve system according to claim 1, wherein
the closure component has at least one closure side configured to interact with the first sealing surface,
a progression of the second sealing surface defines an extension plane for the closure component, and
the closure component comprises at least one coupling element for coupling the closure component to the drive unit, wherein the coupling element extends in the plane of extension or parallel to the plane of extension.

3. The vacuum valve system according to claim 2, wherein the vacuum valve system has a guide component coupled to the coupling element, wherein the coupling to the coupling element is configured in such a way that the closure component can be displaced by means of the coupling relative to the guide component in a direction orthogonally to the plane of extension, in particular parallel.

4. The vacuum valve system according to claim 1, wherein
the valve seat assembly has a second valve opening and a third sealing surface surrounding the second valve opening, wherein the second valve opening is opposite the first valve opening and an opening axis defined by the second valve opening is coaxial or parallel to the opening axis of the first valve opening; and
the closure component is configured for substantially gas-Light closing of the second valve opening and includes a fourth sealing surface corresponding to the third sealing surface, wherein the third and/or the fourth sealing surface comprises a second sealing material.

5. The vacuum valve system according to claim 1, wherein characterized in that
the progressions of first and second sealing surfaces each have first and second main sections and two side sections,
the two main sections lie in planes which are at right angles to the opening axis and are spaced apart from each other, and
the two main sections are each connected by the respective two side sections.

6. The vacuum valve system according to claim 5, wherein the sealing material has a Y-shaped cross-section, wherein the two legs of the cross-section contact the first sealing surface of the valve seat assembly in the closed position.

7. A valve seat assembly for a vacuum valve system of a vacuum transport system, wherein the vacuum transport system has a transport tube for transporting an object internally along the transport tube, comprising a valve opening defining an opening axis and a first sealing surface surrounding the valve opening, wherein
the valve seat assembly is designed as a system component which can be combined in a modular manner with a closure component of the vacuum valve system and interacts in combination,
the valve seat assembly can be combined with the transport tube in such a way that a gas-tight transition is provided between the valve seat assembly and the transport tube, and the valve opening corresponds to a tube cross-section.

8. The valve seat assembly according to claim 7, wherein the valve seat assembly is designed as an insert element for insertion into a receptacle on the transport system side, wherein a spatial extension and shape of the insert element is provided in such a way that the insert element can be inserted into the receptacle with an accurate fit and, by inserting the insert element into the receptacle, a valve seat for the vacuum valve system is provided for closing and opening the vacuum transport system as a whole or in segments.

9. The valve seat assembly according to claim 7, wherein the valve seat assembly is provided by a valve tube segment of the vacuum transport system, wherein the valve seat assembly is formed as a non-detachable, fixedly connected part of the vacuum transport system and is integrated into the vacuum transport system, in particular in one piece.

10. The valve seat assembly according to claim 9, wherein the valve seat assembly is formed as a cast part of the vacuum transport system, and is at least one of a mineral casting, metal casting or concrete casting.

11. The valve seat assembly according to claim 7, wherein the valve seat assembly comprises a guide and a receiving arrangement for receiving the closure component, wherein the guide provides guidance for movement of the closure component from an open position to a closed position and back.

12. The valve seat assembly according to claim 7, wherein the valve seat assembly has a spatial extension of at least 2 times the diameter of the transport tube of the vacuum transport system.

13. The valve seat assembly according to claim 7, wherein the valve seat assembly comprises a second valve opening and a third sealing surface surrounding the second valve opening, wherein the second valve opening is opposite the first valve opening and an opening axis defined by the second valve opening is coaxial or parallel to the opening axis of the first valve opening.

14. A vacuum transport system, comprising
a transport tube for transporting an object in the interior along the transport tube, wherein a negative pressure, in particular a vacuum, can be provided in the interior of the transport tube relative to the surrounding atmosphere, and
a vacuum valve system which is integrated in the vacuum transport system and connected to the transport tube, wherein
the valve seat assembly is connected to the transport tube to provide:
a gas-tight transition is provided between the valve seat assembly and the transport tube, and
the vacuum valve system and the transport tube form an overall enclosed arrangement providing separation between the surrounding atmosphere and an interior of the vacuum transport system,
the valve seat assembly provides the first valve opening and the first sealing surface inside the vacuum transport system,
the first valve opening corresponds to a tube cross-section,
the valve seat assembly and the closure component are combined and interact,
a controlled movement of the closure component into the open position and the closed position can be provided by means of the drive unit,
and an inner volume of the vacuum transport system can be closed as a whole or in segments, in particular can be separated, and can be opened.

15. The vacuum transport system according to claim 14, wherein the object is a transport means, and wherein the transport means is designed for transporting a person and/or goods.

16. A casting tool configured to produce a valve seat assembly, wherein the casting tool defines an inner volume having at least one filling opening for introducing a casting material, and the inner volume that
defines an outer wall having a transport tube opening, with two opposing transport tube openings, wherein the transport tube opening corresponds in shape and spatial extension to a transport tube of a vacuum transport system, and
defines an inner structure and the inner structure defines a valve opening and a first sealing surface surrounding the valve opening,
wherein the casting tool is designed to be multi-part or closable so that the inner volume is provided by assembling or closing the casting tool and the inner volume is eliminated by separating or opening the casting tool, wherein an opening axis defined by the valve opening extends coaxially or parallel to a tube axis defined by the transport tube opening.

17. A method for manufacturing a valve seat assembly of a vacuum valve system of a vacuum transport system, comprising:
providing a casting tool;
positioning the casting tool close to or in contact with a transport tube of a vacuum transport system;
introducing a casting material into the casting tool;
hardening of the casting material; and
opening or separating and removing the casting tool.

18. (canceled)
